(19) United States
(12) Patent Application Publication
(10) Pub. No.: US 2015/0027567 A1
(43) Pub. Date: Jan. 29, 2015

(54) BACK PRESSURE REGULATION

(71) Applicant: Waters Technologies Corporation, Milford, MA (US)

(72) Inventors: Joshua A. Shreve, Franklin, MA (US); John M. Auclair, Seekonk, MA (US); Paul Keenan, Harrisville, RI (US); Edwin Denecke, North Attleboro, MA (US); Gerald Wisser, Gibsonia, PA (US); Edward Bates, Natrona Heights, PA (US); Eugene Berthiaume, Cumberland, RI (US); Michael Bower, Hopkinton, MA (US)

(73) Assignee: Waters Technologies Corporation, Milford, MA (US)

(21) Appl. No.: 14/382,602

(22) PCT Filed: Mar. 4, 2013
(86) PCT No.: PCT/US13/28822

§ 371 Date: Sep. 3, 2014

Related U.S. Application Data
(60) Provisional application No. 61/608,282, filed on Mar. 8, 2012.

(51) Int. Cl. F16K 1/52; F16K 15/06; F16K 25/04

(52) U.S. Cl. CPC F16K 1/52; F16K 25/04; F16K 15/06
USPC 137/528

(57) ABSTRACT

The invention generally provides a dynamic back pressure regulator. In exemplary embodiments, the back pressure regulator includes an inlet, an outlet, a seat disposed between the inlet and the outlet and defining at least part of a fluid pathway, and a needle displaceable relative to the seat to form a restriction region therebetween for restricting fluid flow between the inlet and the outlet. In some embodiments, the needle can be formed of a chemically resistant ceramic or have a metal plating to provide corrosion and/or erosion resistance.

### RELATED APPLICATION

This application claims priority to and benefit of U.S. Provisional Patent Application No. 61/608,282 entitled “Back Pressure Regulation,” filed Mar. 8, 2012, which is incorporated by reference herein in its entirety.

### TECHNICAL FIELD

This disclosure relates to back pressure regulation, and, in one particular implementation, to a dynamic back pressure regulator for a supercritical fluid chromatography system.

### BACKGROUND

Supercritical fluid chromatography (SFC) is a chromatographic separation technique that typically utilizes liquefied carbon dioxide (CO2) as a mobile phase solvent. In order to keep the mobile phase in liquid (or liquid-like density) form, the chromatographic flow path is pressurized; typically to a pressure of at least 1100 psi.

### SUMMARY

This disclosure is based, in part, on the realization that a dynamic back pressure regulator can be provided with a chemically resistant ceramic needle for improved resistance to corrosion and/or erosion.

One aspect provides a dynamic back pressure regulator that includes an inlet, an outlet, a seat disposed between the inlet and the outlet and defining at least part of a fluid pathway, and a needle displaceable relative to the seat to form a restriction region therebetween for restricting fluid flow between the inlet and the outlet. The needle is formed of a chemically resistant ceramic.

Another aspect features a supercritical fluid chromatography (SFC) system that includes a separation column, at least one pump configured to deliver a mobile phase fluid flow comprising liquefied CO2 toward the separation column, an inject valve configured to introduce a sample plug into the mobile phase fluid flow, and a dynamic back pressure regulator disposed downstream of, and in fluid communication with, the column for regulating pressure in the system. The dynamic back pressure regulator includes an inlet, an outlet, a seat disposed between the inlet and the outlet and defining at least part of a fluid pathway, and a needle displaceable relative to the seat to restrict fluid flow between the inlet and the outlet. The needle is formed of a chemically resistant ceramic.

According to another aspect, a method includes delivering a mobile phase fluid flow comprising liquefied carbon dioxide (CO2) from a chromatography toward a dynamic back pressure regulator; and passing the mobile phase fluid flow through a restriction region in the dynamic back pressure regulator defined by a chemically resistant ceramic needle and a seat.

Yet another aspect provides a dynamic back pressure regulator that includes an inlet, an outlet, a seat disposed between the inlet and the outlet and defining at least part of a fluid pathway, and a needle displaceable relative to the seat to form a restriction region therebetween for restricting fluid flow between the inlet and the outlet. The needle has a metal plating (e.g., a gold plating or a platinum plating).

Implementations can include one or more of the following features.

In some implementations, the chemically resistant ceramic is selected from zirconia, sapphire, and ruby.

In some implementations, the chemically resistant ceramic or the needle formed therefrom can be subjected to a hot isostatic pressing (HIP) process.

In certain implementations, the seat is at least partially formed of a polymer (e.g., polyether-ether-ketone).

In some implementations, the polymer is filled with between 20 and 50 wt. % carbon fiber (e.g., about 30 wt. % carbon fiber).

In certain implementations, the needle includes a proximal end, a distal end, an elongate shaft extending between the proximal and distal ends, and a cone formed at the distal end.

In some implementations, the cone has an included angle of about 30 degrees to about 60 degrees.

In certain implementations, the total displacement of the needle relative to seat is about 0.001 inches to about 0.005 inches.

In some implementations, the dynamic back pressure regulator also includes a solenoid configured to limit displacement of the needle relative to the seat to control the restriction of fluid flow.

In certain implementations, the dynamic back pressure regulator also includes a head defining a portion of the fluid pathway, and a body connecting the solenoid to the head.

In some implementations, the needle includes a proximal end that extends into the body, and a distal end that extends into the head.

In certain implementations, the dynamic back pressure regulator also includes a seat nut that engages the head to secure the seat therebetween.

In some implementations, the head defines the inlet port and the seat nut defines the outlet port.

In certain implementations, the dynamic back pressure regulator includes a seal disposed between the head and the body, wherein the needle extends through the seal.

In some implementations, the seal is at least partially formed of an ultra high molecular weight polyethylene.

In certain implementations, the dynamic back pressure regulator includes a bushing disposed between the head and the body, wherein the needle extends through the bushing.

In some implementations, the dynamic back pressure regulator is configured to regulate fluid pressure at the inlet port to a pressure within the range of about 1500 psi to about 6000 psi.

In certain implementations, a flow of electrical current to the dynamic back pressure regulator is changed to adjust the size of the restriction region.

In some implementations, the step of delivering the mobile phase fluid flow from the chromatography column toward the dynamic back pressure regulator includes: delivering the mobile phase fluid flow from the chromatography column toward a detector, and then delivering the mobile phase fluid flow from the detector toward the dynamic back pressure regulator.

Implementations can provide one or more of the following advantages.

Implementations provide a needle that is resistant to corrosion, erosion, or any combination thereof in the back pressure regulator environment of a supercritical fluid chromatography system.

Other aspects, features, and advantages are in the description, drawings, and claims.

### BRIEF DESCRIPTION OF THE DRAWINGS

FIG. 1 is a schematic view of a supercritical fluid chromatography (SFC) system;

FIG. 2 is a schematic view of a dynamic back pressure regulator from the SFC system of FIG. 1; and

FIG. 3 is perspective view of a needle from the dynamic back pressure regulator of FIG. 2.

Like reference numbers indicate like elements.

### DETAILED DESCRIPTION

### System Overview

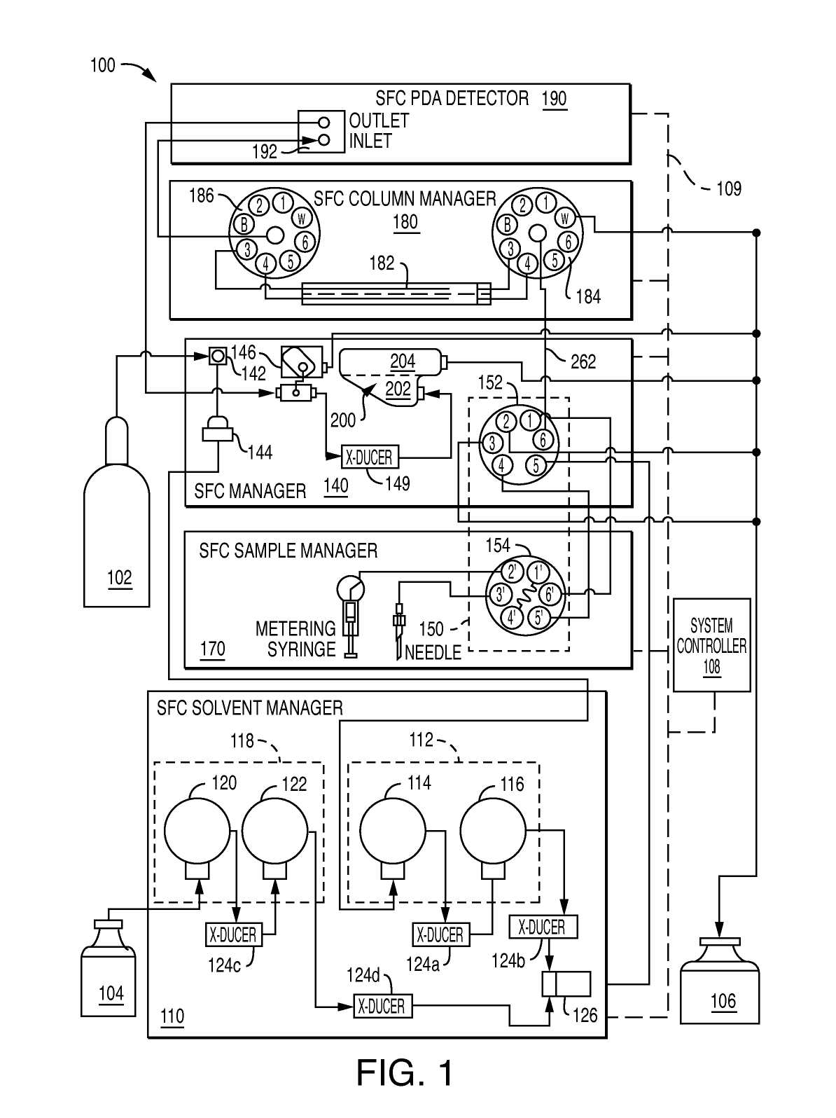

FIG. 1 schematically depicts a supercritical fluid chromatography (SFC) system 100. The SFC system 100 includes a plurality of stackable modules including a solvent manager 110; an SFC manager 140; a sample manager 170; a column manager 180; and a detector module 190.

The solvent manager 110 is comprised of a first pump 112 which receives carbon dioxide (CO2) from CO2 source 102 (e.g., a tank containing compressed CO2). The CO2 passes through an inlet shutoff valve 142 and a filter 144 in the SFC manager 140 on its way to the first pump 112. The first pump 112 can comprise one or more actuators each comprising or connected to cooling means, such as a cooling coil and/or a thermoelectric cooler, for cooling the flow of CO2 as it passes through the first pump 112 to help ensure that the CO2 fluid flow is deliverable in liquid form. In some cases, the first pump 112 comprises a primary actuator 114 and an accumulator actuator 116. The primary and accumulator actuators 114, 116 each include an associated pump head, and are connected in series. The accumulator actuator 116 delivers CO2 to the system 100. The primary actuator 114 delivers CO2 to the system 100 while refilling the accumulator actuator 116.

In some cases, the solvent manager 110 also includes a second pump 118 for receiving an organic co-solvent (e.g., methanol, water (H2O), etc.) from a co-solvent source 104 and delivering it to the system 110. The second pump 118 can comprise a primary actuator 120 and an accumulator actuator 122, each including an associated pump head. The primary and accumulator actuators 120, 122 of the second pump 118 are connected in series. The accumulator actuator 122 delivers co-solvent to the system 100. The primary actuator 120 delivers co-solvent to the system 100 while refilling the accumulator actuator 122.

Transducers 124a-d are connected to outlets of the respective pump heads for monitoring pressure. The solvent manager 110 also includes electrical drives for driving the primary actuators 114, 120 and the accumulator actuators 116, 122. The CO2 and co-solvent fluid flows from the first and second pumps 112, 118, respectively, and are mixed at a tee 126 forming a mobile phase fluid flow that continues to an injection valve subsystem 150, which injects a sample slug for separation into the mobile phase fluid flow.

In the illustrated example, the injection valve subsystem 150 is comprised of an auxiliary valve 152 that is disposed in the SFC manager 140 and an inject valve 154 that is disposed in the sample manager 170. The auxiliary valve 152 and the inject valve 152 are fluidically connected and the operations of these two valves are coordinated to introduce a sample plug into the mobile phase fluid flow. The inject valve 154 is operable to draw up a sample plug from a sample source (e.g., a vial) in the sample manager 170 and the auxiliary valve 152 is operable to control the flow of mobile phase fluid into and out of the inject valve 154. The SFC manager 140 also includes a valve actuator for actuating the auxiliary valve 152 and electrical drives for driving the valve actuations. Similarly, the sample manager 170 includes a valve actuator for actuating the inject valve and 154 and electrical drives for driving the valve actuations.

From the injection valve subsystem 150, the mobile phase flow containing the injected sample plug continues through a separation column 182 in the column manager 180, where the sample plug is separated into its individual component parts. The column manager 180 comprises a plurality of such separation columns, and inlet and outlet switching valves 184, 186 for switching between the various separation columns.

After passing through the separation column 182, the mobile phase fluid flow continues on to a detector 192 (e.g., a flow cell/photodiode array type detector) housed within the detector module 190 then through a vent valve 146 and then on to a back pressure regulator assembly 200 in the SFC manager 140 before being exhausted to waste 106. A transducer 149 is provided between the vent valve 146 and the back pressure regulator assembly 200.

The back pressure regulator assembly 200 includes a dynamic (active) back pressure regulator 202 and a static (passive) back pressure regulator 204 arranged in series. The dynamic back pressure regulator 202, which is discussed in greater detail below, is adjustable to control or modify the system fluid pressure. This allows the pressure to be changed from run to run. The properties of CO2 affect how quickly compounds are extracted from the column 182, so the ability to change the pressure can allow for different separation based on pressure.

The static back pressure regulator 204 is a passive component (e.g., a check valve) that is set to above the critical pressure, to help ensure that the CO2 is liquid through the dynamic back pressure regulator 202. The dynamic back pressure regulator 202 can control more consistently when it is liquid on both the inlet and the outlet. If the outlet is gas, small reductions in the restriction can cause the CO2 to gasify upstream of the dynamic back pressure regulator 202 causing it to be unable to control. In addition, this arrangement helps to ensure that the static back pressure regulator 204 is the location of phase change. The phase change is endothermic, therefore the phase change location may need to be heated to prevent freezing. By controlling the location of phase change, the heating can be simplified and localized to the static back pressure regulator 204.

Generally, the static back pressure regulator 204 is designed to keep the pressure at the outlet of the dynamic back pressure regulator 202 below 1500 psi but above the minimum pressure necessary to keep the CO2 in liquid phase. In some cases, the static back pressure regulator 204 is designed to regulate the pressure within the range of about 1150 psi (at minimum flow rate) to about 1400 psi (at maximum flow rate). The dynamic back pressure regulator 202 can be used to regulate system pressure in the range of about 1500 psi to about 6000 psi.

Also shown schematically in FIG. 1 is a computerized system controller 108 that can assist in coordinating operation of the SFC system 100. Each of the individual modules 110, 140, 170, 180, 190 also includes its own control electronics, which can interface with each other and with the system controller 108 via an Ethernet connection 109. The control electronics for each module can include non-volatile memory with computer-readable instructions (firmware) for controlling operation of the respective module's components (e.g., the pumps, valves, etc.) in response to signals received from the system controller 108 or from the other modules. Each module's control electronics can also include at least one processor for executing the computer-readable instructions, receiving input, and sending output. The control electronics can also include one or more digital-to-analog (D/A) converters for converting digital output from one of the processors to an analog signal for actuating an associated one of the pumps or valves (e.g., via an associated pump or valve actuator). The control electronics can also include one or more analog-to-digital (A/D) converters for converting an analog signal, such as from system sensors (e.g., pressure transducers), to a digital signal for input to one of the processors. In some cases, some or all of the various features of these control electronics can be integrated in a microcontroller.

### Dynamic Back Pressure Regulator

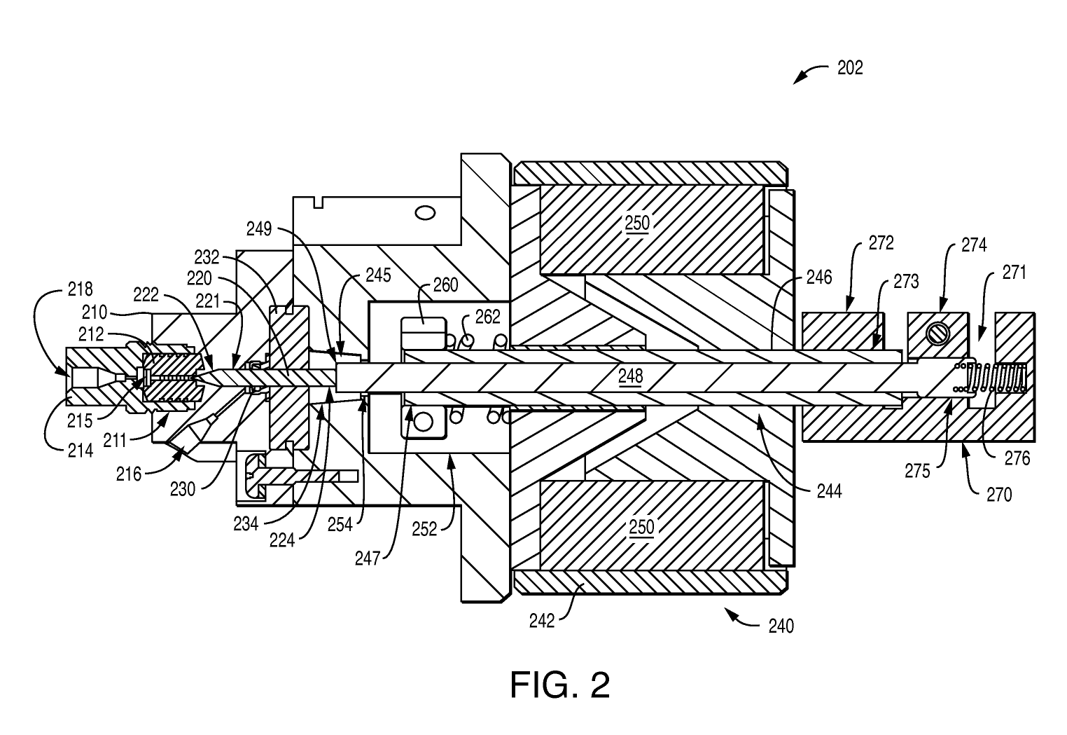

Referring to FIG. 2, an implementation of a dynamic back pressure regulator 202 for use in chromatographic separations includes a body 208, a head 210 fastened to the body 208, a seat 212, and a seat nut 214 which is threadingly received within a counterbore 211 in the head 210 securing the seat 212 therebetween. The head 210, the seat 212, and the seat nut 214 together define a fluid pathway 215 that connects an inlet port 216 in the head 210 to an outlet port 218 in the seat nut 214. That is, the fluid pathway 215 is formed by the interconnection of cavities and passageways in the head 210, the seat 212, and the seat nut 214. The inlet and outlet ports 216, 218 are each configured to receive a standard compression screw and ferrule connection for connecting fluidic tubing.

The dynamic back pressure regulator 202 also has a needle 220 which extends into the fluid pathway 215. The needle 220 is displaceable relative to the seat 212 to adjust a restriction region defined between the needle 220 and the seat 212 for controlling fluid flow through the fluid pathway 215. During operation, the total displacement of the needle 220 is between about 0.001 inches and 0.005 inches. For example, at about 2000 psi the displacement of the needle 220 is barley 0.001 inches, leaving about a 0.001 inch gap between the needle 220 and seat 212 where fluid can flow. Consequently, the fluid velocity within the dynamic back pressure regulator 202 tends to be high. In general, during normal operation, the needle 220 is not intended to completely seal against the seat 212 in a manner that completely stops flow, but instead is intended to merely restrict the flow to achieve the desired pressure. The seat 212 can be manufactured from polyether-ether-ketone, such as PEEK™ polymer (available from Victrex PLC, Lancashire, United Kingdom), filled with between 20 and 50 wt. % (e.g., 30 wt. %) carbon fiber.

The needle 220 is supported in a through hole 221 in the head 210 and is arranged such that a distal end 222 of the needle 220 is in the fluid pathway 215. The needle 220 passes through a seal 230 which inhibits flowing fluids from passing into the body 208 and extends through a bushing 232. The bushing 232 is secured between the head 210 and a body 208 which is connected to the head 210 (e.g., by means of fasteners such as screws). A proximal end 224 of the needle 220 extends outwardly from the bushing 232 and into a first cavity 234 in the body 208.

The needle 220 can be actuated by a solenoid 240 which is connected to the body 208 (e.g., by means of fasteners such as screws). The solenoid 240 comprises a housing 242 and a plunger 244 that includes an outer shaft 246 and an inner shaft 248. An electrical coil 250 for activating the solenoid 240 is disposed within the housing 242. A distal end portion 245 of the plunger 244 extends through a second cavity 252 in the body 208 and into the first cavity 234 via a reduced diameter through hole 254. When the solenoid 240 is activated, a distal end 249 of the inner shaft 248 pushes against the proximal end 224 of the needle 220, which displaces the needle 220 towards the seat 212 to restrict fluid flow. Pressure force (fluid) will move the needle 220 until the fluidic pressure force on the needle 220 matches the force applied by the solenoid 240. In this regard, the fluid pressure creates whatever restriction is necessary to equalize the pressure force from the solenoid.

A balancing spring collar 260 is fastened about a distal end 247 of the plunger's outer shaft 246 and retains a balancing spring 262 between the housing 242 and the balancing spring collar 260. The balancing spring 262 is provided to balance the solenoid 240 to have minimal force change through the working stroke of the plunger 244. As the plunger 244 moves out of the magnetic field the force drops off. The balancing spring 262 is selected to make the spring rate positive so that the plunger 244 has a returning force. The chosen spring adds an equivalent to slightly higher positive (stabilizing) spring rate.

A calibration collar 270 is fastened about a proximal end portion 271 of the plunger 244. The calibration collar 270 includes a first clamping section 272 that secures the calibration collar 270 to the proximal end 273 of the outer shaft 246, and a second clamping section 274 that secures the calibration collar 270 to the inner shaft 248. The calibration collar 270 secures a calibration spring 276 between the proximal end 275 of the inner shaft 248 and the calibration collar 270. The calibration spring 276 proves for a mechanical self calibration of the plunger 244 during assembly. That is, during assembly of the dynamic back pressure regulator 202 the first clamping section 272 is fastened to the proximal end 273 of the outer shaft 246 while the second clamping section 274 is left loose to allow the inner shaft 248 to move relative the outer shaft 246. This allows the calibration spring 276 to move the inner shaft 248 into contact with the needle 220. Consequently, the needle 220 is moved into contact with the seat 212, thereby calibrating the needle position. The engagement of the needle 220 with the seat 212 also helps to center the needle 220 and the seat 212. The second clamping section 274 can then be fastened to the inner shaft 248 to inhibit movement of the inner shaft 248 relative to the outer shaft 246 during normal operation.

### Needle

During operation, the dynamic back pressure regulator 202 in the SFC system 100 can provide an exceptionally corrosive and erosive environment for the needle 220 and the seat 212. The combination of CO2 and water or organic solvent can be very corrosive. In addition, the high velocity flow through the needle 220 and seat 212 in the dynamic back pressure regulator 202 can expose the needle 220 and seat 212 to significant erosive forces. When the two conditions are combined the needle 220 and the seat 212 are exposed to a highly destructive environment, which can lead to degradation of the needle 220, and, consequently, loss of control over the pressure. The pressure drop across the dynamic back pressure regulator 202, from between about 1500 psi to about 6000 psi at the inlet of the dynamic back pressure regulator to between about 1150 psi to about 1400 psi at the outlet of the dynamic back pressure regulator 202 may also result in localized phase change of the CO2 along the needle 220 which can also contribute to erosion.

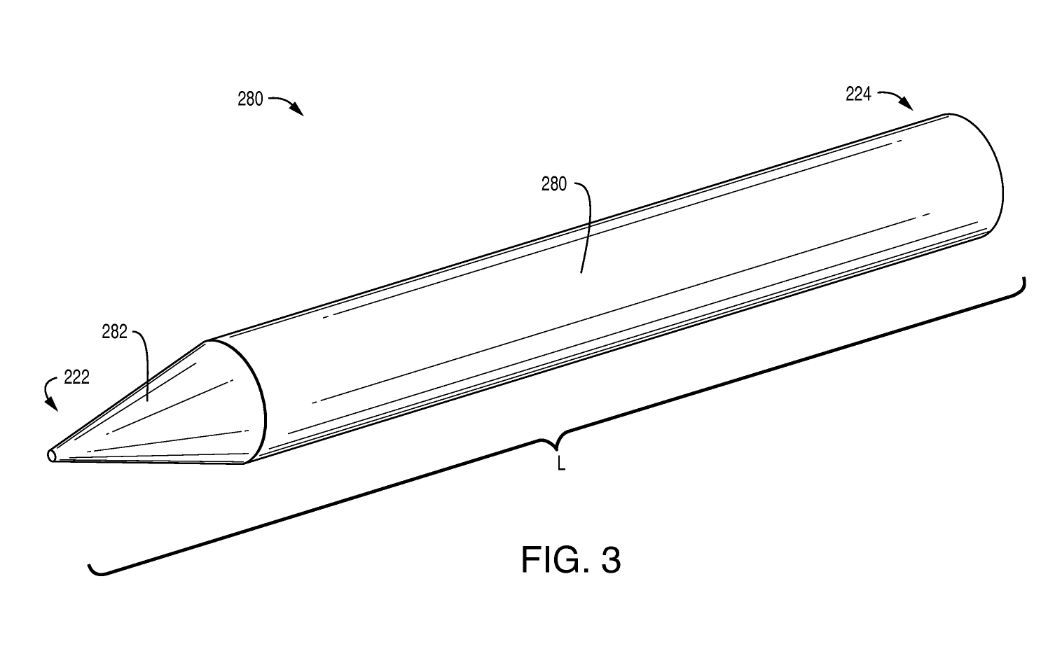

In the following, the needle 220 is described in more detail with reference to FIG. 3. Notably, the needle 220 can be formed from a chemically resistant ceramic material, such as zirconia. The utilization of such material can allow the needle 220 to survive the harsh environment that it is exposed to. In some embodiments, the needle can be formed from a ceramic material, e.g., zirconia, that has been subjected to a hot isostatic pressing (HIP) process. In other embodiments, the needle can be formed from a ceramic material, e.g., zirconia, by a hot isostatic pressing (HIP) process. In further embodiments, the needle can be formed from a ceramic material, e.g., zirconia, and subsequently treated using a hot isostatic pressing (HIP) process. HIP processing of the needle or the ceramic material from which it is formed can reduce the porosity of the material which can increase the corrosion and erosion resistance of the needle.

The needle 220 is designed with a simple geometry to allow easy manufacturing of the zirconia. Zirconia is very resistant to corrosion and is a very durable ceramic material. The needle 220 includes an elongate shaft 280 that extends from the proximal end 224 to the distal end 222. The needle 220 has an overall length L of about 0.75 inches to about 1.5 inches. The needle 220 has a diameter of about 0.124 inches to about 0.126 inches (e.g., about 0.125 inches), which leaves a clearance of about 0.005 inches between the shaft 280 and the through hole 221 (FIG. 2) in the head 210 following assembly. The needle 220 can be formed from standard 0.125 inch zirconia rod stock to help minimize the amount of material to be removed.

A tapered portion in the shape of a cone 282 is formed at the distal end 222 of the needle 220 via a grinding process. The cone 282 has an included angle of about 30 degrees to about 60 degrees. The cone 282 cooperates with the seat 212 to restrict fluid flow. The cone 282 also helps to center the seat 212 during assembly. That is, during assembly, as the seat nut 214 is tightened into the head 210 the cone 282 engages a cavity in the proximal end of the seat 212 which assists in centering the seat 212.

The zirconia can also be polished to a very smooth surface finish Ra of about 5 μinches to about 6 μinches, which can help to reduce frictional forces. The zirconia also couples well and provides a low friction interface with the seal 230 material (e.g., UP-30 from Bal Seal, an ultra high molecular weight polyethylene (UHMWPE) compound with other materials blended in to improve friction and wear properties).

It was found that this needle combined with a carbon fiber filled PEEK seat is extremely well suited to this environment and has shown little to no wear over time. A dynamic back pressure regulator 202 with this arrangement of needle and seat materials remained fully functional following testing at 100 liters of flow at a flow rate of 4 mL/min through the restriction region.

### Other Implementations

Although a few implementations have been described in detail above, other modifications are possible. For example, while an implementation of a dynamic back pressure regulator having a zirconia needle has been described, the needle may instead be formed of another chemically resistant ceramic, such as alumina Al2O3 ceramics (e.g., sapphire, ruby).

While an implementation has been described in which the needle is formed of a chemically resistant ceramic, in some cases only the tapered tip is formed of the chemically resistant ceramic such that the ceramic is present in the restriction region. For example, another implementation of the needle includes a chemically resistant ceramic (e.g., zirconia, sapphire, etc.) tip that threadingly connects to a stainless steel shaft.

Although an implementation of a dynamic back pressure regulator having a chemically resistant ceramic needle has been described, in some implementations, the needle, or a portion thereof, may be formed of a metal (e.g., stainless steel, aluminum, gold, platinum, etc.).

In some cases, the needle, or a portion thereof (e.g., the tip) is covered with a metal plating (e.g., gold plating or platinum plating). For example, the needle can be formed of a metal, such as stainless steel, which is covered with a gold or platinum plating at least in the region of the tip.

While an implementation of a dynamic back pressure regulator has been described which uses a solenoid for regulating the displacement of the needle relative to the seat, some implementations may utilize another type of actuator, e.g., a linear position component, such as a voice coil, for regulating the displacement of the needle.

In addition, although described with respect to SFC applications, the principles can be implemented in back pressure regulators used in other applications which involve the handling of corrosive fluids and/or high velocity fluid flows. In some instances, for example, the back pressure regulators described herein may be desirable for regulating system pressure in other types of chromatography systems, such as high performance liquid chromatography (HPLC) systems.

Accordingly, other implementations are within the scope of the following claims.

1. A dynamic back pressure regulator comprising:
an inlet,
an outlet,
a seat disposed between the inlet and the outlet and defining at least part of a fluid pathway;
a needle displaceable relative to the seat to form a restriction region therebetween for restricting fluid flow between the inlet and the outlet,
wherein the needle is formed of a chemically resistant ceramic.

2. The dynamic back pressure regulator of claim 1, wherein the chemically resistant ceramic is selected from zirconia, sapphire, and ruby.

3. The dynamic back pressure regulator of claim 1, wherein the seat is at least partially formed of a polymer.

4. The dynamic back pressure regulator of claim 3, wherein the polymer is polyether-ether-ketone.

5. The dynamic back pressure regulator of claim 3, wherein the polymer is filled with between 20 and 50 wt. % carbon fiber.

6. The dynamic back pressure regulator of claim 5, wherein the polymer is filled with about 30 wt. % carbon fiber.

7. The dynamic back pressure regulator of claim 1, wherein the needle comprises:
a proximal end,
a distal end,
an elongate shaft extending between the proximal and distal ends, and
a cone formed at the distal end.

8. The dynamic back pressure regulator of claim 7, wherein the cone has an included angle of about 30 degrees to about 60 degrees.

9. The dynamic back pressure regulators of claim 1, wherein the total displacement of the needle relative to seat is about 0.001 inches to about 0.005 inches.

10. The dynamic back pressure regulator of claim 1, further comprising a solenoid configured to limit displacement of the needle relative to the seat to control the restriction of fluid flow.

11. The dynamic back pressure regulator of claim 10, further comprising;
a head defining a portion of the fluid pathway, and
a body connecting the solenoid to the head,

12. The dynamic back pressure regulator of claim 11, wherein the needle comprises a proximal end that extends into the body, and a distal end that extends into the head.

13. The dynamic back pressure regulator of claim 11, further comprising a seat nut that engages the head to secure the seat therebetween.

14. The dynamic back pressure regulator of claim 13, wherein the head defines the inlet port and the seat nut defines the outlet port.

15. The dynamic back pressure regulator of claim 11, further comprising a seal disposed between the head and the body, wherein the needle extends through the seal.

16. The dynamic back pressure regulator of claim 15, wherein the seal is at least partially formed of a ultra high molecular weight polyethylene.

17. The dynamic back pressure regulator of claim 11, further comprising a bushing disposed between the head and the body, wherein the needle extends through the bushing.

18. The dynamic back pressure regulator of claim 1, wherein the dynamic back pressure regulator is configured to regulate fluid pressure at the inlet port to a pressure within the range of about 1500 psi to about 6000 psi.

19-32. (canceled)

33. The dynamic back pressure regulator of claim 1,
wherein the needle comprises a metal plating.

34. The dynamic back pressure regulator of claim 33, wherein the metal plating is selected from the group consisting of a gold plating and a platinum plating.
